(19) United States
(12) Patent Application Publication
(10) Pub. No.: US 2020/0001241 A1
(43) Pub. Date: Jan. 2, 2020

(54) DRAWN SILICONE MEMBRANES

(71) Applicant: WACKER CHEMIE AG, Munich (DE)

(72) Inventors: Christian Tobias Anger, München (DE); Barbara Moser, Gauting (DE); Richard Weidner, Burghausen (DE)

(21) Appl. No.: 16/490,348

(22) PCT Filed: Mar. 3, 2017
(86) PCT No.: PCT/EP2017/055050

§ 371 Date: Aug. 30, 2019

(51) Int. Cl. B01D 67/00; B01D 71/70; C08L 83/04; C08K 3/013

(52) U.S. Cl. CPC B01D 67/0027; B01D 67/0011; B01D 71/70; C08L 83/04; B01D 2325/02; B01D 2323/30; C08L 2203/16; B01D 2323/21; B01D 2323/28; C08K 3/013

(57) ABSTRACT

The invention relates to a method for producing thin, porous membranes from crosslinkable silicone compositions (S), in which: in a first step, a mixture of the silicone compositions (S) with a pore forming agent (P) and, where appropriate, solvent (L) is formed; in a second step, the mixture is placed in a mould and the silicone composition (S) is vulcanised and any solvent (L) present is removed, producing a crosslinked membrane with pores, in a third step, the pore forming agent (P) in removed from the crosslinked membrane; and in a fourth step, the pores of the membrane are opened by stretching. The invention also relates to the membranes produced in this manner and to the use thereof for separating mixtures, in wound plasters, as packaging materials and as textile membranes.

The invention relates to a process for producing drawn, microporous silicone membranes, and also to the membranes obtainable therewith, and to their use.

Membranes are thin porous moldings and find application in separating mixtures. A further application arises in the textiles sector, as breathable, water-repellent membrane, for example. Often used in this context are coagulated polyurethane membranes with an asymmetric microporosity (Loeb-Sourirajan process). Alternative microporous membranes are based on biaxially oriented polytetrafluoroethylene.

Production of porous silicone membranes by the Loeb-Sourirajan process is known. For example, JP59225703 teaches the production of a porous silicone membrane from a silicone-carbonate copolymer. This process exclusively produces an anisotropic pore size along the film layer thickness. In addition, a separate precipitation bath is always required in this case.

DE102010001482 further teaches the production of isotropic silicone membranes by means of an evaporation-induced phase separation. A disadvantage with this process, however, is the fact that it requires thermoplastic silicone elastomers, with the consequence that the membranes obtainable accordingly are much less temperature-stable than comparable thin silicone rubber sheets. Furthermore, thermoplastic silicone elastomers exhibit an unwanted phenomenon referred to as “cold flow”, causing the porous membranes to change their membrane structure under sustained loading.

Conversely, US2004234786 describes silicone rubber membranes starting from aqueous emulsions, or DE102007022787 describes fiber-reinforced silicone rubber membranes, which are distinguished by their thermal stability and the absence of the “cold flow”. A disadvantage with these processes, however, is that the only membranes obtainable accordingly are non-porous, and so, while they can be used as a water barrier layer, they do not exhibit any substantial water vapor permeability. Here it would be advantageous if, instead of the silicone copolymers mentioned in these patent specifications, it were possible to produce thin porous membranes based on pure silicone rubbers, these membranes, on account of their crosslinked structure, being thermally stable and non-fluid, and hence not displaying any “cold flow”. Likewise advantageous would be the production of isotropic porous silicone membranes.

A subject of the invention is a process for producing thin porous membranes from crosslinkable silicone compositions (S), wherein

a first step comprises forming a mixture from the silicone compositions (S) with a pore-former (P) and optionally solvent (L),

a second step comprises introducing the mixture into a mold and vulcanizing the silicone composition (S), and removing any solvent present (L), where a crosslinked membrane with pores is formed,

a third step comprises removing the pore-former (P) from the crosslinked membrane, and

a fourth step comprises opening the pores of the membrane by drawing.

Surprisingly it has been found here that pores in membranes made of crosslinked silicone rubber can be opened irreversibly by drawing and that these drawn membranes exhibit a symmetrically isotropic distribution. Additionally and unexpectedly, the layer thickness after drawing and after relaxation of the membranes is greater than before drawing. Known silicone rubbers can be used.

The drawing procedure here is critical, since the diffusion of water vapor, for example, can be accelerated by a multiple factor.

A procedure of this kind for producing porous silicone membranes has not been described before and could not have been expected in this way.

By using silicone membranes of symmetrically isotropic microporosity it is possible to achieve high water vapor permeabilities, of the kind required in textile membrane applications, for example. Moreover, the symmetrically isotropic distribution of the pores significantly increases their mechanical stability. This is accompanied by the advantage of very high water columns. Water penetrates such silicone membranes only at a water pressure of more than 1 bar.

The crosslinking of the silicone compositions (S) to form membranes is preferably via covalent bonds, of the kind forming, for example, through condensation reactions, addition reactions or radical mechanisms. Particularly preferred is the crosslinking of liquid silicones, thus having viscosities of up to a maximum of 300 000 MPa or of gellike or high-viscosity silicones, thus having viscosities of more than 2 000 000 MPa, such silicones being sold, for example, by Wacker Chemie AG under the ELASTOSIL® brand.

Silicone compositions (S) used are preferably liquid silicones (LSRs).

A preferred liquid silicone (LSR) is an addition-crosslinkable silicone composition (S), comprising
(A) polyorganosiloxane containing at least two alkenyl groups per molecule and having a viscosity at 25° C. of 0.2 to 1000 Pa·s,
(B) SiH-functional crosslinking agent,
(C) hydrosilylation catalyst
(I) and inhibitor.

The polyorganosiloxane (A) containing alkenyl groups preferably possesses a composition of the average general formula (1)

R¹ₓR²_{y}SiO_{(4-x-y)}/2 (1),

in which
R¹ is a monovalent, optionally halogen- or cyano-substituted C₁-C₁₀ hydrocarbon radical which comprises aliphatic carbon-carbon multiple bonds and is optionally bonded to silicon via an organic divalent group,
R² is a monovalent, optionally halogen- or cyano-substituted C₁-C₁₀ hydrocarbon radical which is free from aliphatic carbon-carbon multiple bonds and is SiC-bonded,
x is a non-negative number such that there are at least two radicals R¹ in each molecule, and
y is a non-negative number such that (x+y) lies in the range from 1.8 to 2.5.

The alkenyl groups R¹ are applicable in an addition reaction with an SiH-functional crosslinking agent (B). Alkenyl groups used typically have 2 to 6 carbon atoms, such as vinyl, allyl, methallyl, 1-propenyl, 5-hexenyl, ethynyl, butadienyl, hexadienyl, cyclopentenyl, cyclopentadienyl, cyclohexenyl, preferably vinyl and allyl.

Organic divalent groups via which the alkenyl groups R¹ can be bonded to polymer chain silicon consist of, for example, oxyalkylene units, such as those of the general formula (2)

—(O)ₘ[(CH₂)ₙO]ₒ— (2),

where

m is 0 or 1, especially 0,

n is from 1 to 4, especially 1 or 2, and

o is from 1 to 20, especially from 1 to 5.

The oxyalkylene units of general formula (2) are bonded to a silicon atom on the left-hand side.

The radicals R¹ can be attached in every position of the polymer chain, especially to the terminal silicon atoms.

Examples of unsubstituted radicals R² are alkyl radicals, such as methyl, ethyl, n-propyl, isopropyl, n-butyl, isobutyl, tert-butyl, n-pentyl, isopentyl, neopentyl, tert-pentyl; hexyl radicals, such as n-hexyl; heptyl radicals, such as n-heptyl; octyl radicals, such as n-octyl and isooctyl radicals, such as 2,2,4-trimethylpentyl; nonyl radicals, such as n-nonyl; decyl radicals, such as n-decyl; alkenyl radicals, such as vinyl, allyl, n-5-hexenyl, 4-vinylcyclohexyl and 3-norbornenyl; cycloalkyl radicals, such as cyclopentyl, cyclohexyl, 4-ethylcyclohexyl, cycloheptyl, norbornyl and methylcyclohexyl; aryl radicals, such as phenyl, biphenylyl, naphthyl; alkaryl radicals, such as o-, m-, p-tolyl and ethylphenyl; and aralkyl radicals, such as benzyl, alpha-phenylethyl and β-phenylethyl radicals.

Examples of substituted hydrocarbon radicals R² are halogenated hydrocarbons, such as chloromethyl, 3-chloropropyl, 3-bromopropyl, 3,3,3-trifluoropropyl, and 5,5,5,4,4,3,3-heptafluoropentyl, and also chlorophenyl, dichlorophenyl, and trifluorotolyl.

R² preferably has 1 to 6 carbon atoms. Methyl and phenyl are particularly preferred.

Constituent (A) can also be a mixture of various alkenyl-containing polyorganosiloxanes which differ in the alkenyl group content, in the nature of the alkenyl group or structurally, for example.

The structure of alkenyl-containing polyorganosiloxanes (A) can be linear, cyclic or branched. The level of tri- and/or tetrafunctional units leading to branched polyorganosiloxanes is typically very low, preferably not more than 20 mol % and especially not more than 0.1 mol %.

Particular preference is given to using vinyl-containing polydimethyisiloxanes, the molecules of which conform to general formula (3)

(ViMe₂SiO_{1/2})₂(ViMeSiO)ₚ(Me₂SiO)_{q} (3),

where the non-negative integers p and q satisfy the following relations: p≥0, 50<(p+q)<20 000, preferably 200<(p+q)<1000, and 0<(p+q)<0.2. Especially p is =0.

The viscosity of polyorganosiloxane (A) at 25° C. is preferably 0.5 to 500 Pa·s, especially 1 to 100 Pa·s and very preferably 1 to 50 Pa·s.

The organosilicon compound (B), which contains two or more SiH functions per molecule, preferably possesses a composition of the average general formula (4)

HₐR³_{b}SiO_{(4-a-b)}/2 (4),

where
R³ is a monovalent, optionally halogen- or cyano-substituted C₁-C₁₈ hydrocarbon radical which is free of aliphatic carbon-carbon multiple bonds and is bonded via SiC, and
a and b are, on integers,

with the proviso that 0.5<(a+b)<3.0 and 0<a<2, and that there are at least two silicon-bonded hydrogen atoms per molecule.

Examples of R³ are the radicals indicated for R². R³ preferably has 1 to 6 carbon atoms. Methyl and phenyl are, particularly preferred.

The use of an organosilicon compound (B) which contains three or more SiH bonds per molecule is preferred. When the organosilicon compound (B) used has just two SiH bonds per molecule it is advisable to use a polyorganosiloxane (A) which has three or more alkenyl groups per molecule.

The hydrogen content of organosilicon compound (B), based exclusively on the hydrogen atoms directly bonded to silicon atoms, lies preferably in the range from 0.002% to 1.7% by weight of hydrogen and preferably from 0.1% to 1.7% by weight of hydrogen.

Organosilicon compound (B) preferably contains not less than three and not more than 600 silicon atoms per molecule. The use of organosilicon compound (B) containing 4 to 200 silicon atoms per molecule is preferred.

The structure of organosilicon compound (B) can be linear, branched, cyclic or network-like.

Particularly preferred organosilicon compounds (B) are linear polyorganosiloxanes of general formula (5)

(HR⁴₂SiO_{1/2})_{c}(R⁴₃SiO_{1/2})_{d}(HR⁴SiO_{2/2})ₑ(R⁴₂SiO_{2/2})_{f} (5),

where

R⁴ has the meanings of R³, and

the non-negative integers c, d, e and f satisfy the following relations: (c+d)−2, (c+e)×2, 5<(e+f)<200 and 1<e/(e+f)<0.1.

SiH-functional organosilicon compound (B) is preferably present in the crosslinkable silicone material in such an amount that the molar ratio of SiH groups to alkenyl groups lies at 0.5 to 5 and especially at 1.0 to 3.0.

Hydrosilylation catalyst (C) used can be any known catalyst which catalyzes the hydrosilylation reactions taking place in the course of the crosslinking of addition-crosslinking silicone compositions.

Hydrosilylation catalysts (C) used are, in particular, metals and their compounds from the group consisting of platinum, rhodium, palladium, ruthenium, and iridium.

The use of platinum and platinum, compounds is preferred.

Particular preference is given to platinum compounds which are soluble in polyorganosiloxanes. Soluble platinum compounds used can be, for example, the platinum-olefin complexes of the formulae (PtCl₂.olefin)₂ and H(PtCl₃.olefin), in which case alkenes having 2 to 8 carbon atoms, such as ethylene, propylene, isomers of butene and octane, or cyoloalkenes having 5 to 7 carbon atoms, such as cyclopentene, cyclohexene and cycloheptene, are preferably used. Soluble platinum catalysts further include the platinum-cyclopropane complex of the formula (PtCl₂C₃H₆)₂, the reaction products of hexachloroplatinic acid with alcohols, ethers and aldehydes, or mixtures thereof, or the reaction product of hexachloroplatinic acid with methylvinylcyclotetrasiloxane in the presence of sodium bicarbonate in ethanolic solution. Complexes of platinum with vinylsiloxanes, such as sym-divinyltetramethyldisiloxane, are particularly preferred.

Hydrosilylation catalyst (C) can be used in any desired form including, for example, in the form of microcapsules containing hydrosilylation catalyst, or polyorganosiloxane particles.

The level of hydrosilylation catalysts (C) is preferably chosen such that the addition-crosslinkable silicone composition (S) possesses a Pt content of 0.1 to 200 weight ppm, especially of 0.5 to 40 weight ppm.

Ethynylcyclohexanol, for example, may be used as inhibitor (I).

Silicone composition (S) may comprise at least one filler (D). Non-reinforcing fillers (D) having a BET surface area of up to 50 m²/g include, for example, quartz, diatomaceous earth, calcium silicate, zirconium silicate, zeolites, metal oxide powders, such as aluminum oxide, titanium oxide, iron oxide or zinc oxide and/or mixed oxides thereof, barium sulfate, calcium carbonate, gypsum, silicon nitride, silicon carbide, boron nitride, glass powder and plastics powder. Reinforcing fillers, i.e. fillers having a BET surface area of not less than 50 m²/g and especially 100 to 400 m²/g, include, for example, pyrogenous silica, precipitated silica, aluminum hydroxide, carbon black, such as furnace black and acetylene black, and silicon-aluminum mixed oxides of large BET surface area. Said fillers (D) can be in a hydrophobized state, for example due to treatment with organosilanes, organosilazanes and/or organosiloxanes, or due to etherification of hydroxyl groups into alkoxy groups. One type of filler (D) can be used; a mixture of two or more fillers (D) can also be used.

The filler content (D) of silicone compositions (S) is preferably not less than 3% by weight, more preferably not leas than 5% by weight and especially not less than 10% by weight and not more than 40% by weight.

The silicone compositions (S) may as a matter of choice include possible ingredients as a further constituent (E) at from 0% to 70% by weight and preferably from 0.0001% to 40% by weight. These ingredients may be, for example, resin-type polyorganosiloxanes other than said polyorganosiloxanes (A) and (B), adhesion promoters, pigments, dyes, plasticizers, organic polymers, heat stabilizers and inhibitors. This includes ingredients such as dyes and pigments. Thixotroping constituents, such as finely divided silica or other commercially available thixotropic additives, can also be present as a constituent. Preferably not more than 0.5% by weight, more preferably not more than 0.3% by weight and especially <0.1% by weight of peroxide can also be present as a further constituent (E) for better crosslinking.

Useful pore-formers (P) include all organic low molecular weight compounds which are immiscible with silicones. Examples of pore-formers (P) are monomeric, oligomeric and polymeric glycols.

Preference is given to using glycols of general formula (6)

R⁵—O[(CH₂)_{g}O]ₕ—R⁵ (6),

where

R⁵ represents hydrogen, methyl, ethyl or propyl,

g represents values from 1 to 4, especially 1 or 2, and

h represents values from 1 to 20, especially from 1 to 5.

Preferred examples of glycols are ethylene glycol, diethylene glycol, triethylene glycol, tetraethylene glycol, propylene glycol, dipropylene glycol, monomethyldiethylene glycol, dimethyldiethylene glycol, trimethyldiethylene glycol, low molecular weight polyglycols such as polyethylene glycol 200, polyethylene glycol 400, polypropylene glycol 425 and polypropylene glycol 725.

The pore-formers (P) are added in amounts of preferably from 20 to 2000 parts by weight, more preferably from 30 to 300 parts by weight and especially from 50 to 200 parts by weight, all based on 100 parts by weight of silicone composition (S).

Examples of solvents (L) are ethers, especially aliphatic ethers, such as dimethyl ether, diethyl ether, methyl t-butyl ether, diisopropyl ether, dioxane or tetrahydrofuran, esters, especially aliphatic esters, such as ethyl acetate or butyl acetate, ketones, especially aliphatic ketones, such as acetone or methyl ethyl ketone, sterically hindered alcohols, especially aliphatic alcohols, such as i-propanol, t-butanol, amides such as DMF, aromatic hydrocarbons such as toluene or xylene, aliphatic hydrocarbons such as pentane, cyclopentane, hexane, cyclohexane, heptane, hydrochlorocarbons such as methylene chloride or chloroform.

Solvents or solvent mixtures having a boiling point or boiling range of up to 120° C. at 0.1 MPa are preferred.

Solvents (L) preferably concern aromatic or aliphatic hydrocarbons.

When solvents (L) are used, amounts concerned are preferably from 1 to 300 parts by weight, more preferably from 10 to 200 parts by weight and especially from 20 to 100 parts by weight, all based on 100 parts by weight of silicone composition (S).

The silicone compositions (S), pore-formers (P), and, optionally, solvents (L) are preferably converted in the first step into a homogeneous mixture by applying high shear forces, for example with a Turrax® or Speedmixer®.

In the first step, the temperature at which the mixture is produced is preferably not less than 0° C., more preferably not less than 10° C., especially not less than 20° C. and not more than 60° C., and more preferably not more than 50° C.

The homogeneous mixture preferably comprises not more than one part by weight, more preferably not more than 0.1 part by weight, of surfactants, all based on 100 parts by weight of silicone composition (S), and more particularly comprises no surfactants.

In the second step, the mixture is preferably applied, to form a thin membrane, by means of blade coating, for example.

For production of the membranes, the mixture in the second step is applied preferably to a substrate.

Preferred geometric embodiments of thin porous membranes that can be produced are foils, tubes, fibers, hollow fibers, mats, the geometric shape not being tied to any fixed forms, but being very largely dependent on the substrates used. The mixtures applied to substrates are preferably further processed into foils.

The substrates preferably comprise one or more materials from the group encompassing metals, metal oxides, polymers or glass. The substrates here are in principle not tied to any geometric shape. However, it is preferable to use substrates in the form or plates, foils, textile sheet substrates, woven or preferably non-woven meshes, or more preferably in the form of nonwoven webs.

Substrates based on polymers contain for example polyamides, polyimides, polyetherimides, polycarbonates, polybenzimidazoles, polyethersulfones, polyesters, polyaulfones, polytetrafluoroethylenes, polyurethanes, polyvinyl chlorides, cellulose acetates, polyvinylidene fluorides, polyether glycols, polyethylene terephthalate (PET), polyaryletherketones, polyacrylonitrile, polymethyl methacrylates, polyphenylene oxides, polyethylenes or polypropylenes. Preference is given here to polymers having a glass transition temperature Tg of at least 80° C. Substrates based on glass contain for example quarts glass, lead glass, float glass or lime-soda glass.

Preferred mesh or web substrates contain glass, carbon, aramid, polyester, polyethylenes, polypropylenes, polyethylenes/polypropylenes copolymer or polyethylene terephthalate fibers.

The layer thickness of substrates is preferably ≥1 μm, more preferably ≥10 μm and even more preferably ≥100 μm and preferably ≤2 mm, more preferably ≤100 μm and even more preferably ≤50 μm. The most preferred ranges for the layer thickness of substrates are, the ranges formulatable from the aforementioned values.

The thickness of the porous membranes is chiefly determined by the coating height.

Any technically known form of applying the mixture to substrates can be employed to produce the porous membranes. The mixture is preferably applied to the substrate using a blade or via meniscus coating, casting, spraying, dipping, screen printing, intaglio printing, transfer coating, gravure coating or spin-on-disk. The mixtures thus applied have film thicknesses of preferably ≥10 μm, more, preferably ≥100 μm, especially ≥200 μm and preferably ≤10 000 μm, more preferably ≤5000 μm, especially ≤1000 μm. The most preferred ranges for the film thicknesses are the ranges formulatable from the aforementioned values.

The mixture in the second step is introduced into a mold preferably at temperatures of at least 0° C., more preferably at least 10° C., more particularly at least 20° C., and at most 60° C., more preferably at most 50° C.

Subsequently, in the third step, the mixture introduced into the mold is vulcanized.

Where low-boiling solvent (L) is used, it is advantageous for the solvent to be removed before the vulcanization, by evaporating from the mixture, for example.

In one preferred embodiment, the solvent (L) is vaporized at the same time as the vulcanization.

The crosslinking of the mixture is preferably effected by irradiation with light or heating, preferably at 30 to 250° C., especially at 150-210° C.

The pore-former (P) can be removed from the membrane in the third step in any method familiar to the skilled person. Examples are extraction, evaporation, gradual solvent exchange, or simple was of the pore-former (P) with solvent. Examples of suitable solvents include water and the solvents (L) stated above.

In a likewise preferred embodiment of the invention, the pore-former (P) is removed in the third step by extraction. Extraction here is preferably done with a solvent which does not destroy the porous structure formed, but is readily miscible with pore former (P). It is particularly preferable to use water as extractant. Extraction preferably takes place at temperatures between 20° C. and 100° C. The preferred extraction time can be determined in a few tests for the particular system. The extraction time is preferably at least 1 second to several hours. And the operation can also be repeated more than once.

The membrane is preferably dried to remove the solvent after the third step, preferably at temperatures between 20° C. and 120° C., preferably under pressures of 0.0001 MPa to 0.1 MPa.

The drawing in the fourth step opens pores of the membrane. Drawing takes place preferably at 0° C. to 100° C., more preferably at 10° C. to 50° C.

The drawing in the fourth step may be carried out monoaxially or biaxially. The drawing preferably takes place biaxially.

It is preferable to produce membranes having a uniform, symmetrically isotropic pore distribution along the cross section. It is particularly preferable to produce microporous membranes, having pore sizes of 0 μm to 20 μm.

The membranes preferably possess an isotropic distribution of pores.

The membranes obtained by following the procedure generally have a porous structure. The free volume is preferably at least 5% by volume, more preferably at least 20% by volume and especially at least 35% by volume and at most 90% by volume, more preferably at most 80% by volume and especially at most 75% by volume.

The membranes thus obtained can be used, for example, for separating mixtures. Alternatively, the membranes can be lifted off the substrate and then be used directly without further support or, optionally, applied to other substrates, such as wovens, nonwovens or foils, preferably at elevated temperatures and by employment of pressure, for example in a hot press or in a laminator. To improve adherence to the other substrates, adhesion promoters can be used.

The finalized membranes have layer thicknesses of preferably at least 1 μm, more preferably at least 10 μm, especially at least 50 μm and preferably at most 10 000 μm, more preferably at most 2000 μm, especially at most 1000 μm and even more preferably at most 100 μm.

The membranes thus obtained can be used directly as a membrane, preferably for separating mixtures.

The porous membranes can further also be used in sticking plasters. It is likewise preferable to use the porous membranes in packaging materials especially in the packaging of food items which, after production, for example, undergo still further ripening processes. The membranes are used with particular preference as textile membranes, especially as a water-repellent and/or breathable layer in the construction of textile laminates.

The above symbols in the above formulae all have their respective meanings independently of each other. The silicon atom is tetravalent in all formulae.

In the examples which follow, all amounts and percentages are by weight, all pressures are 101.3 kPa (abs.) and all temperatures and viscosity data are 25° C., unless otherwise stated.

Determination of Viscosities:

Unless otherwise indicated, the viscosities are determined by the method of rotational viscometry in accordance with DIN EN 53019. Unless indicated otherwise, all of the viscosity data are valid at 25° C. and atmospheric pressure of 0.1013 MPa.

Silicones Used:

Silicone Composition Base Material:

Terminally vinyl-functionalized polydimethylsiloxane (viscosity 1000 mPas)

Pyrogenous Silica

H-Polymer 1000:

Si—H functionalized silicone/Si—H content 0.11 mmol/g

Crosslinker H014:

Si—H functionalized siloxane/Si—H content 1.5 mmol/g

Inhibitor PT 88: Ethynylcyclohexanol

Cat EP: Platinum-containing catalyst for hydrosilylation

Vinyl polymer 20000: Terminally vinvl-functionalized polydimethylsiloxane (viscosity 20 000 mPas)

### EXAMPLE 1

### Producing a Liquid Silicone Rubber Solution with Additional Solvent

26.67 g of silicone composition base material, 13.33 g of vinylpolymer 20000 and 66.08 g of toluene are introduced, together with a KOMET PTFE magnetic stirring rod, into a 250 ml laboratory glass flask, with dissolution overnight on a roller bed. 3.618 g of crosslinker H014, 0.4 g of inhibitor PT 88 and 0.04 g of catalyst EP are weighed out into the homogeneous solution and dissolved with stirring. This is followed by slow dropwise addition of 70.49 g of triethylene glycol with vigorous stirring, and by continuation of stirring until the resulting mixture is homogeneous.

### EXAMPLE 2

### Not Inventive: Producing Porous Silicone Rubber Membranes on PTFE Foil

The polymer solution from Example 1 is introduced into a PE beaker, homogenized for 1 minute at 2500 rpm and 0% vacuum and degassed for 1 minute at 2500 rpm and 100% vacuum in a SpeedMixer DAC 400.1 V-DP. A film 250 μm thick is subsequently applied slowly by hand, using a box-type film-drawing frame, onto a Teflon® glass fiber foil, and the solvent is evaporated off in a circulating air drying cabinet at 110° C., with simultaneous vulcanization of the film. After the vulcanization, the crosslinked silicone film comprising pore-former is placed into a water bath at room temperature for at least 8 hours and the polymer membrane is dried at room temperature.

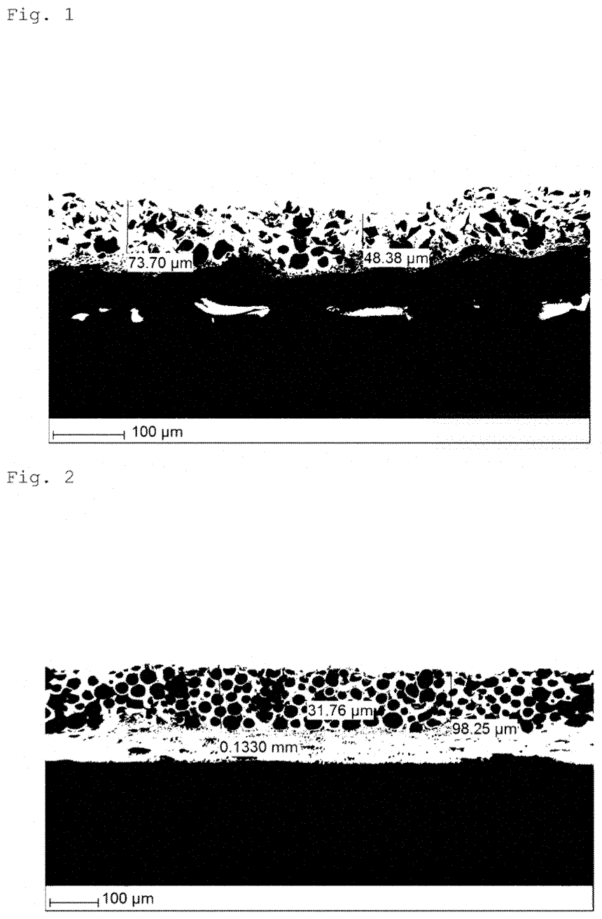

The undrawn membrane from Example 2 is shown in FIG. 1. The pores are predominantly pushed-in and not symmetrically isotropically distributed.

### EXAMPLE 3

### Producing Porous Silicone Rubber Membranes on PTFE Foil

The polymer solution from Example 1 is introduced into a PE beaker, homogenized for 1 minute at 2500 rpm and 0% vacuum and degassed for 1 minute at 2500 rpm und 100% vacuum in a SpeedMixer DAC 400.1 V-DP. A film 250 μm thick is subsequently applied slowly by hand, using a box-type film-drawing frame, onto a Teflon® glass fiber foil, and the solvent is evaporated off in a circulating air drying cabinet at 110° C., with simultaneous vulcanization of the film. After the vulcanization, the crosslinked silicone film comprising pore-former is placed into a water bath at room temperature for at least 8 hours. After the washed-off polymer film has dried, the pores are opened by biaxial drawing.

The drawn membrane from Example 3 is shown in FIG. 2. The pores are predominantly spherical in shape and are symmetrically isotropically distributed.

### EXAMPLE 4

### Determining the Water Vapor Permeability Performance of Biaxially Drawn Silicone Membranes

The water vapor permeability is determined by the JIS 1099 A1 method.

The water vapor permeability is 5642 g/m²*24 h at a layer thickness of 100 μm.

### EXAMPLE 5

### Not Inventive: Determining the Water Vapor Permeability Performance of Undrawn Silicone Membranes

The water vapor permeability is determined by the JIS 1099 A1 method.

The water vapor permeability is 2.542 g/m²*24 h at a layer thickness of 500 μm.

### EXAMPLE 6

### Pressure Testing

To test the mechanical stability of the membrane under pressure, the membrane is placed for 3 days between two rubber rollers which press against one another with an applied pressure of 7 kg weight. The morphology of the membrane is retained even under pressure.

### EXAMPLE 7

### Producing a Liquid Silicone Rubber Solution with Additional Solvent

40.00 g of silicone composition base material and 66.42 g of toluene are introduced, together with a KOMET PTFE magnetic stirring rod, into a 250 ml laboratory glass flask, with dissolution overnight on a roller bed. 3.84 g of crosslinker H014, 0.4 g of inhibitor PT 88 and 0.04 g of catalyst EP are weighed out into the homogeneous solution and dissolved with stirring. This is followed by slow dropwise addition of 70.49 g of triethylene glycol with vigorous stirring, and by continuation of stirring until the resulting mixture is homogeneous.

### EXAMPLE 8

### Not Inventive: Producing Porous Silicone Rubber Membranes on PTFE Foil

The polymer solution (Example 7) is introduced into a PE beaker, homogenized for 1 minute at 2500 rpm and 0% vacuum and degassed for 1 minute at 2500 rpm and 100% vacuum in a SpeedMixer DAC 400.1 V-DP. A film 250 μm thick is subsequently applied slowly by hand, using a box-type film-drawing frame, onto a Teflon® glass fiber foil, and the solvent is evaporated off in a circulating air drying cabinet at 110° C., with simultaneous vulcanization of the film. After the vulcanization, the crosslinked silicone film comprising pore-former is placed into a water bath at room temperature for at least 8 hours and the polymer membrane is dried at room temperature.

### EXAMPLE 9

### Producing Porous Silicone Rubber Membranes on PTFE Foil

Place the polymer solution (Example 7) into a PE beaker, homogenize for 1 minute at 2500 rpm and 0% vacuum and degass for 1 minute at 2500 rpm and 100% vacuum in a SpeedMixer DAC 400.1 V-DP. A film 250 μm thick is subsequently applied slowly by hand, using a box-type film-drawing frame, onto a Teflon® glass fiber foil, and the solvent is evaporated off in a circulating air drying cabinet at 110° C., with simultaneous vulcanization of the film. After the vulcanization, the crosslinked silicone film comprising pore-former is placed into a water bath at room temperature for at least 8 hours. After the washed-off polymer film has dried, the pores are opened by biaxial drawing.

### EXAMPLE 10

### Determining the Water Vapor Permeability Performance of Biaxially Drawn Silicone Membranes

The water vapor permeability is determined by the JIS 1099 A1 method.

The water vapor permeability of the membrane from Example 9 is 3895 g/m²*24 h at a layer thickness of 55 μm.

### Example 11

### Not Inventive: Determining the Water Vapor Permeability Performance of Undrawn Silicone Membranes

The water vapor permeability is determined by the JIS 1099 A1 method.

The water vapor permeability of the membrane from Example 8 is 1767 g/m²*24 h at a layer thickness of 54 μm.

1. A process for producing thin porous membranes from crosslinkable silicone compositions (S), wherein
a first step comprises forming a mixture from the silicone compositions (S) with a pore-former (P) and optionally solvent (L),
a second step comprises introducing the mixture into a mold and vulcanizing the silicone composition (S), and removing any solvent present (L), where a crosslinked membrane with pores is formed,
a third step comprises removing the pore-former (P) from the crosslinked membrane, and
a fourth step comprises opening the pores of the membrane by drawing.

2. The process as claimed in claim 1, wherein an addition-crosslinkable silicone composition (S) is used, comprising
(A) polyorganosiloxane containing at least two alkenyl groups per molecule and having a viscosity at 25° C. of 0.2 to 1000 Pa·s,
(B) SiH-functional crosslinking agent,
(C) hydrosilylation catalyst, and
(I) inhibitor.

3. The process as claimed in claim 2, wherein the polyorganosiloxane (A) containing alkenyl groups has a composition of the average general formula (1)
R¹ₓR²_{y}SiO_{(4-x-y)}/2 (I)
in which
R¹ is a monovalent, optionally halogen- or cyano-substituted C₁-C₁₀ hydrocarbon radical which comprises aliphatic carbon-carbon multiple bonds and is optionally bonded to silicon via an organic divalent group,
R² is a monovalent, optionally halogen- or cyano-substituted C₁-C₁₀ hydrocarbon radical which is free from aliphatic carbon-carbon multiple bonds and is SiC-bonded,
x is a non-negative number such that there are at least two radicals R¹ in each molecule, and
y is a non-negative number such that (x+y) lies in the range from 1.8 to 2.5.

4. The process as claimed in one or more of claims 2 and 3, wherein the organosilicon compound (B) has a composition of the average general formula (4)
HₐR³_{b}SiO_{(4-a-b)}/2 (4),
in which
R³ is a monovalent, optionally halogen- or cyano-substituted hydrocarbon radical which is free from aliphatic carbon-carbon multiple bonds and is SiC-bonded, and
a and b are non-negative integers
with the proviso that 0.5<(a+b)<3.0 and 0<a<2, and that there are at least two silicon-bonded hydrogen atoms per molecule.

5. The process as claimed in one or more of claims 2 to 4, wherein the hydrosilylation catalyst (C) is selected from metals and their compounds from the group consisting of platinum, rhodium, palladium, ruthenium, and iridium.

6. The process as claimed in one or more of claims 2 to 5, wherein the silicone composition (s) comprises at least one filler (D).

7. The process as claimed in one or more of claims 1 to 6, wherein the pore-former (P) is selected from monomeric, oligomeric, and polymeric glycols.

8. The process as claimed in one or more of claims 1 to 7, wherein 20 to 2000 parts by weight of pore-former (P) are added, based on 100 parts by weight of silicone composition (S).

9. The process as claimed in one or more of claims 1 to 8, wherein the drawing takes place biaxially.

10. A membrane producible by the process as claimed in one or more of claims 1 to 9.

11. The use of a membrane as claimed in claim 10 for separating mixtures, in sticking-plasters or as textile membrane.
